(19) United States
(12) Patent Application Publication
(10) Pub. No.: US 2013/0151401 A1
(43) Pub. Date: Jun. 13, 2013

(54) REDEMPTION OF GIFT CARDS

(71) Applicants: German Scipioni, San Jose, CA (US); Alexander McClure, San Jose, CA (US); Loc Nguyen, San Jose, CA (US)

(72) Inventors: German Scipioni, San Jose, CA (US); Alexander McClure, San Jose, CA (US); Loc Nguyen, San Jose, CA (US)

(21) Appl. No.: 13/714,102

(22) Filed: Dec. 13, 2012

Related U.S. Application Data
(60) Provisional application No. 61/570,190, filed on Dec. 13, 2011.

(51) Int. Cl. G06Q 20/34

(52) U.S. Cl. CPC G06Q 20/348
USPC 705/39

(57) ABSTRACT

A method and system for facilitating the redemption of gift cards are described. The method includes linking a gift card issued by a merchant to a user account, receiving a payment request from the user, processing the payment request so that the merchant is paid with funds in the account, receiving a transaction identifier from the merchant, identifying the merchant, verifying that the account is linked to a gift card issued by the merchant, retrieving a value of the gift card, transmitting the transaction identifier and a request to redeem the gift card, and receiving and depositing funds corresponding to a full or partial value of the gift card.

### CROSS REFERENCE TO RELATED APPLICATION

The present application is related to and claims priority to U.S. Provisional Patent Application No. 61/570,190, filed Dec. 13, 2011, which is incorporated by reference in its entirety.

### BACKGROUND

1. Field of the Invention

The present invention generally relates to gift card transactions and the redemption of gift cards.

2. Related Art

The use of gift cards to purchase goods or services from a merchant is known. Gift cards may provide a form of payment for a particular merchant that may be used at a point of sales. For example, a clothing retailer may issue plastic gift cards that include magnetic strips similar to credit cards, where the gift cards are associated with credit to pay for purchases. Typically, a gift card recipient presents the gift card to the merchant during a transaction. The payment due is then deducted from the gift card.

Using the gift card usually requires that the gift card recipient carry the gift card so that the gift card can be presented to the merchant during a payment transaction. This may be inconvenient, especially if the recipient has a multiple number of gift cards, since the recipient would be carrying these gift cards in a purse or wallet. Gift cards can also be easily stolen when carried. Furthermore, many consumers often forget to bring the gift card prior to going to a store, or the remaining amount in a gift card can be forgotten.

Thus, it is desirable to provide methods and systems that facilitate the redemption of gift cards.

### BRIEF DESCRIPTION OF THE DRAWINGS

FIG. 1 is a block diagram of a networked system suitable for implementing the methods described herein according to an embodiment;

FIG. 2 is a flowchart showing a method of redeeming a gift card according to one embodiment;

FIG. 3 is a flowchart showing a method of redeeming a gift card according to another embodiment;

FIG. 4 is a flowchart showing a method of redeeming a gift card according to yet another embodiment;

FIG. 5 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

One or more embodiments of the present disclosure relate to facilitating financial transactions using the value on a gift card. In various implementations, a user makes a purchase and slides a value card at a merchant payee device. Funds from a user account maintained by a service provider are used to pay for the purchase. Subsequently, in a separate transaction, funds corresponding to a full or partial balance of the gift card are transferred from the merchant to the service provider.

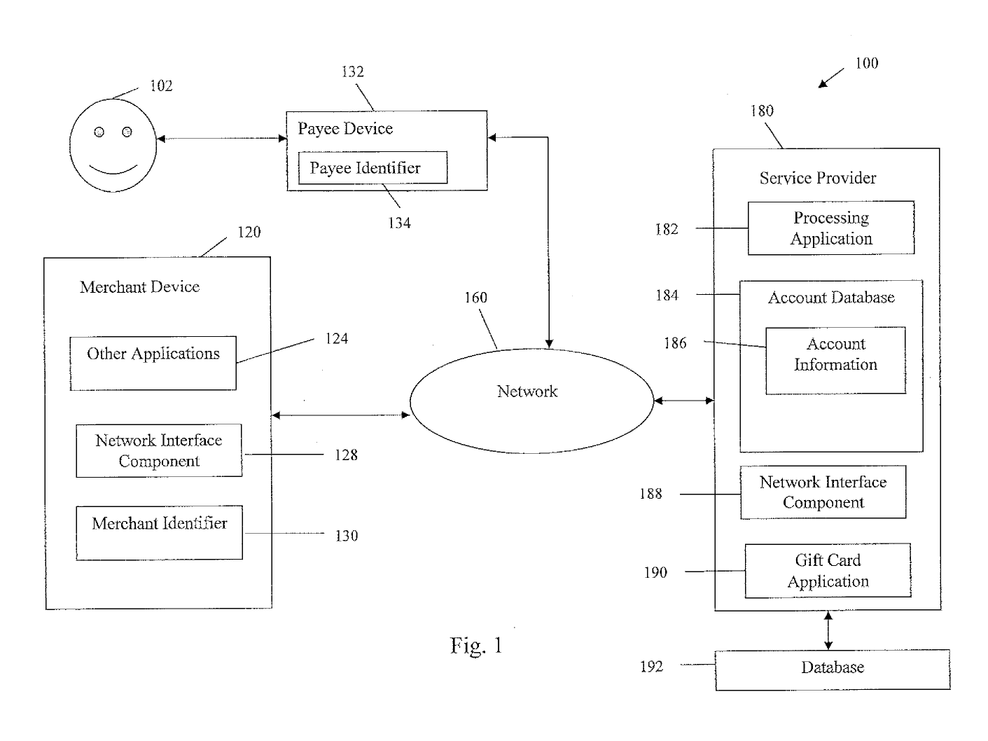

FIG. 1 illustrates an exemplary embodiment of a network-based system 100 for implementing one or more processes described herein over a network 160. As shown, network-based system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities. As shown in FIG. 1, the system 100 includes at least one merchant device 120, at least one payee device 132, and at least one service provider server 180 in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network may comprise a wireless telecommunications network (e.g., mobile cellular phone network) adapted to communicate with other communication networks, such as the Internet.

The merchant device 120 may be maintained by one or more service providers (e.g., merchant sites, auction site, marketplaces, social networking sites, etc.) offering various items, such as products and/or services, through stores created through the service provider or their websites. Merchant device 120 may be in communication with a merchant server capable of handling various on-line transactions. The merchant (which could be any representative or employee of the merchant) can process online transactions from consumers making purchases through a physical or online merchant site.

The merchant device 120, in various embodiments, may be implemented using any appropriate combination of hardware and/or software configured for wired and/or wireless communication over the network 160. In various examples, the merchant device 120 may be implemented as a wired and/or wireless communication device (e.g., an automated user interface device) to communicate with the network 160, such as the Internet and/or mobile network.

The merchant device 120 communicates with the service provider server 180 to transfer a value associated with a gift card to the service provider after a purchase by user 102 at the payee device 132. When user 102 swipes a value card at payee device 132, details of the payment transaction are transmitted to service provider server 180. Service provider server 180 withdraws the payment amount from an account associated with the user and pays for the good or service purchased. Service provider server then transmits the details to merchant device 120 and requests that an amount corresponding to a full or partial value of a gift card is transferred to service provider.

The merchant device 120, in various embodiments, may include one or more other applications 124 to provide additional features. For example, these other applications 124 may include security applications for implementing client-side security features, programmatic client applications for interfacing with appropriate application programming interfaces (APIs) over the network 160 or various other types of generally known programs and/or applications.

The merchant device 120, in one embodiment, may include at least one network interface component (NIC) 128 adapted to communicate with the network 160. In various examples, the network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The merchant device 120, in one embodiment, may include one or more merchant identifiers 130, which may be implemented as operating system registry entries, identifiers associated with hardware of the merchant device 120, and/or various other appropriate identifiers. The merchant identifier 130 may include attributes related to the merchant device 120, such as identification information (e.g., a merchant serial number, a location address, Global Positioning System (GPS) coordinates, a network identification number, etc.) and network information (e.g., network owner, network provider, network administrator, network security information, etc.). In various implementations, the merchant identifier 130 may be passed with network traffic data and information to the service provider server 180, and the merchant identifier 130 may be used by the service provider server 180 to associate one or more network transactions of user 102 with one or more particular user financial accounts maintained by the service provider server 180.

The payee device 132, in one embodiment, may be utilized by user 102 to interact with the service provider server 180 over the network 160. For example, user 102 may conduct financial transactions (e.g., payment of a merchant) with the service provider server 180 via the payee device 132. The payee device 132 may include one or more payee device identifiers 134, which may be implemented as operating system registry entries, identifiers associated with hardware of the payee device 134, and/or various other appropriate identifiers. The payee device identifier 134 may include attributes related to the payee device 132, such as identification information (e.g., merchant associated with the payee device 132, a location address, Global Positioning System (GPS) coordinates, etc.). In various implementations, the payee device identifier 134 may be passed with network traffic data and information to the service provider server 180, and the payee device identifier 134 may be used by the service provider server 180 to associate one or more network transactions of user 102 with one or more particular user financial accounts maintained by the service provider server 180. In various implementations, the payee device 132 may include a magnetic card reader that is integrated with or operatively coupled to merchant device 120 and configured to detect an identifier that is encoded onto a magnetic strip of a value card. The identifier may include the name of user 102, the value card number, the user 102's billing address, expiration date of the value card, etc.

In various implementations, a user profile may be created using data and information obtained from user activity over the network 160. For example, cell phone activity transactions may be used by the service provider server 180 to create at least one user profile for user 102 based on activity from a user mobile device (e.g., cell phone). The user profile may be updated with each financial and/or information transaction (e.g., payment transaction, purchase transaction, etc.) achieved through use of a mobile device. In various aspects, this may include the type of transaction and/or the location information from a mobile device. As such, the profile may be used for recognizing patterns of potential fraud, setting transaction limits on the user, etc.

The service provider server 180, in various embodiments, may be maintained by an online service provider, which is adapted to provide processing for financial transactions on behalf of user 102. The service provider server 180 includes at least one processing application 182, which may be adapted to interact with payee device 132 and merchant device 120 via the network 160 to facilitate financial transactions. In one example, the service provider server 180 may be provided by PayPal, Inc. of San Jose, Calif., USA.

The service provider server 180, in one embodiment, may be configured to maintain a plurality of user accounts in an account database 184, each of which may include account information 186 associated with individual users, including the user 102. For example, account information 186 may include identity information of user 102, such as one or more full names, street addresses, email addresses and phone numbers, or other types of financial information, which may be used to facilitate online transactions between user 102 and the service provider. Account information or identity application may also include location information of users. In another example, account information 186 may include identification information and/or private financial information of user 102, such as account numbers, identifiers, passwords, phone numbers, credit card information, banking information, or other types of financial information, which may be used to facilitate transactions of user 102 at the payee device 132. It should be appreciated that the methods and systems described herein may be modified to accommodate users that may or may not be associated with at least one existing user account.

The service provider server 180, in various embodiments, may include at least one network interface component (NIC) 188 adapted to communicate with the network 160 including the network interface component 128 of the merchant device 120 and the payee device 132. In various implementations, the network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The service provider server 180, in various embodiments, may include one or more databases 192 (e.g., internal and/or external databases) for storing and tracking information related to financial transactions between particular users, such as user 102, and the service provider server 180. For example, the database 192 may provide a historical survey of financial transactions between user 102 and the service provider. As such, in one implementation, the processing application 182 may be configured to track, log, store, and access financial transaction information and provide this information to the processing application 182 for analysis and maintenance. In another embodiment, the database 192 is configured to store information related to gift card transactions, including, but not limited to name of the issuer of a gift card, the latest balance on the gift card, the terms of the gift card, a linked financial account of user 102, a digital picture of the gift card, a digital picture of the bar code, and a serial number of the gift card.

The database 192 may also store, for example, address data for calling or contacting a mobile device of user 102. The address data may include data for communicating a text message to the mobile device, an e-mail address at which messages are receivable by the mobile device, or any other manner for communicating with the mobile device so as to enable the communication to be provided to user 102 during the conduct of a particular transaction at payee device 132. Moreover, service provider server 180 may include computer executable instructions that are operative to cause the server 180 to generate message content appropriate for messages to be communicated to the mobile device.

The service provider server 180 also includes a gift card application 190, which is configured to associate a value of a gift card with a financial account of user 102. The value of the gift card may be stored in a storage device such as database 192. The gift card application 190 allows user 102 to scan one or more physical gift cards so that the monetary value associated with the scanned gift card can be retrieved from the issuer of the card and stored in database 192. In one embodiment, user 102 may scan the bar code on a gift card with his mobile device. The value of the scanned gift card is determined by communicating with an issuer of the gift card. e.g., a merchant.

The gift card application 190 may include a scanner module that receives a digital image of the gift card from a mobile device. User 102 may take a picture of the bar code of the gift card with his mobile device. The scanner module then processes the captured image of the gift card to extract the issuer name (e.g. merchant or bank name), unique account number, serial number, expiration date, and so forth using, for example, an optical character recognition (OCR) algorithm.

In another embodiment, user 102 scans a unique Radio Frequency Identification (RFID) tag associated with the gift card, and the scanner module receives the RFID tag associated with the gift card. In yet another embodiment, user 102 scans a unique magnetic stripe from the gift card, and the scanner receives the code from the magnetic stripe associated with the gift card.

In other embodiments, the scanner may be configured to receive an email from the issuer of the gift card with information regarding the serial number, bar code, code for the gift card, value, expiration date, etc. In one embodiment, the scanner is configured to receive a manual entry from user 102 about a gift card.

The gift card application 190 is also configured to retrieve the value of the gift card from an issuer of the gift card, e.g., merchant, based on data received regarding the gift card (e.g., digital picture, bar code, RFID tag, magnetic strip). In one embodiment, gift card application 190 contacts the issuer of the gift card by contacting the merchant device 120 via the network 160 to obtain the current or latest balance or value of the gift card. In another embodiment, gift card application 190 communicates with a third party to determine the latest balance or value of the gift card. The third party may then contact the issuer of the gift card and then communicate the balance left on the gift card to gift card application 190.

In one embodiment, the merchant device 120 transmits the balance of the gift card to service provider server 180 before user 102 pays for a purchase. The gift card application 190 associates the retrieved value of the gift card with user 102. As such, if the balance of the scanned gift card is ten dollars, service provider server 180 can request ten dollars from merchant device 120 on behalf of user 102. The financial account of user 102 is debited first when user 102 performs a payment transaction (e.g. purchase of an item at a merchant store), and is later credited by a full or partial value of a gift card.

In one embodiment, the gift card can be replenished by transferring money to the issuer (or a third party) of the gift card. For example, user 102 may transfer money from his personal checking account to a financial account associated with the issuer of the gift card.

In yet another embodiment, several scanned gift cards, whether they are from the same or different issuers, can be combined into a single financial account of user 102. For example, user 102 may have several gift cards with the same or different amounts from “The XYZ store.” The scanner module may receive a digital picture for each gift card from the same issuer. The gift card application 190 combines the total value from all the gift cards and stores their value in database 182. As such, user 102 does not have to keep track of the individual value of each gift card from the same issuer. The gift card application 190 enables user 102 to perform a payment transaction with the single financial account of user 102 without having to keep track of the multiple gift cards from the same or different issuer.

When the cost of the purchase is deducted from the financial account of user 102, the gift card application 190 may retrieve an updated value of the gift card from the issuer of the gift card. The gift card application 190 queries the balance of the gift card from an issuer of the gift card based on the previously received data of the gift card.

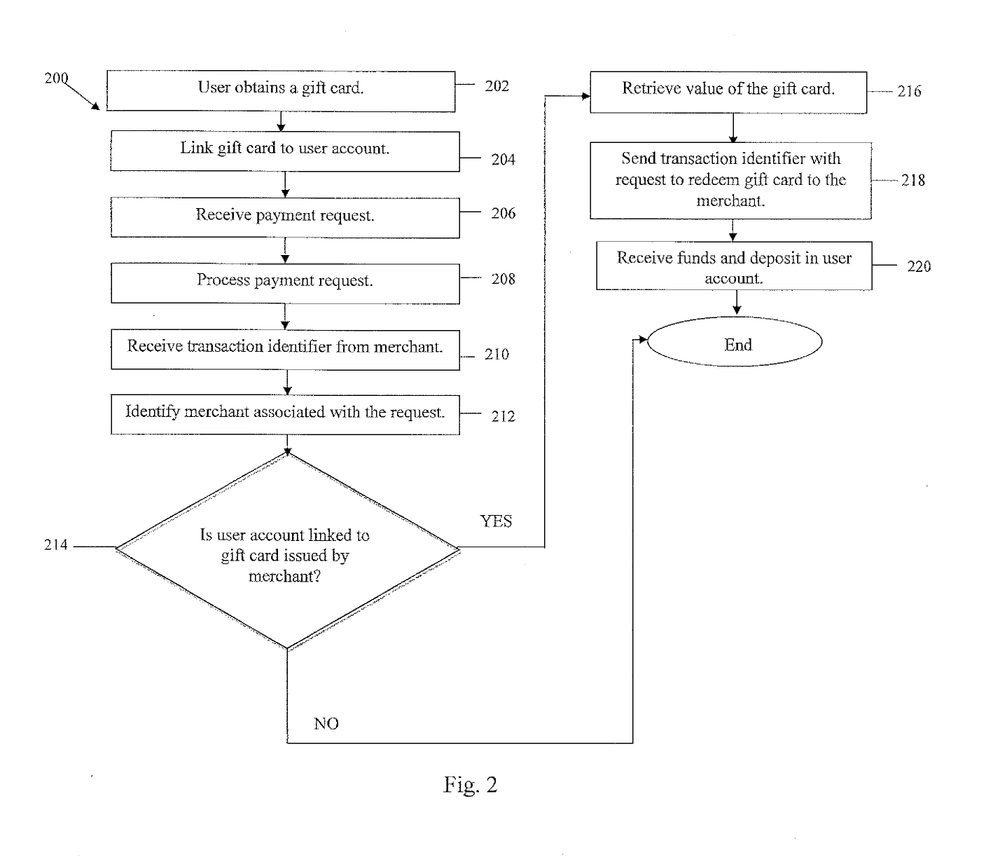

FIG. 2 is a flow chart 200 showing an asynchronous method of redeeming a gift card, according to an embodiment. At step 202, user 102 obtains a gift card. Typically, user 102 receives the gift card as a gift from another person, but user 102 may purchase the gift card from an issuer of a gift card, e.g., a merchant, for his own use. The merchant takes the money paid for the gift card and places it in, for example, a merchant bank account.

At step 204, the gift card is linked to a financial account of user 102. In one embodiment, user 102 registers with a service provider, such as eBay® or PayPal®, which sets up and maintains user 102's financial account. Registration may include signing up for the service and agreeing to any terms required by the service provider, such as through a user device. In one embodiment, the user device is a mobile computing device, such as a smart phone, a PC, or a computing tablet. In other embodiments, registration may be done completely through the user device, partially through the user device, or without using the user device, such as through a phone call or in-person visit to a representative of the service provider.

User 102 may be requested to provider specific information for registration, such as, but not limited to, a name, address, phone number, e-mail address, a user name for the account, and a password or PIN for the account. The type of information may depend on whether the user already has an account with the service provider. Requested information may be entered through the user device or other means, including voice or manual key entry. Once all the requested information is received and confirmed, the service provider may create an account for the user. Further, user devices that will be used to communicate with the service provider may be registered by user 102.

After the account is created, user 102 can, for example, scan or otherwise provide the gift card information to the service provider. The information includes, but is not limited to gift card issuer, a digital picture of the gift card, a digital picture of the bar code, and a serial number of the gift card. The service provider takes the information and associates it with a financial account of user 102.

In certain embodiments, the service provider supplies user 102 with a value card that is associated with user 102 and his financial account. The value card is any type of card that allows user 102 to purchase goods and services at a merchant terminal, typically by transferring money directly from the user's financial account to the merchant. The value card includes a number, name of user 102, expiration date, name of service provider, etc. For example, the value card may be a PayPal® debit card, a PayPal® credit card, a prepaid card, or PayPal® access card. In one embodiment, a user's mobile device can be configured to act as the value card, using near-field communication (NFC) technology.

When user 102 walks into a merchant store, he can use the value card to pay for a good or service. Once user 102 is ready to pay, information regarding user 102 is inputted into merchant payee device 132, e.g., a point-of-sale (POS) terminal located at a fixed location, such as by sliding the value card through a card reader. In another embodiment, touchtone credit processing services is used so that user 102's information, e.g., card data and transaction amount, are entered without swiping a card.

Once the information is entered, payee device 132 contacts service provider server 180 and passes along the user information. At step 206, the service provider server 180 receives user 102's payment request.

At step 208, service provider server 180 processes the payment request so that the merchant is paid with funds in user 102's financial account. The in-store transaction is completed.

In one embodiment, service provider server 180 transmits a message to user 102, asking if user 102 want to use the gift card. User 102 can then reply, either agreeing or declining to use the gift card. User 102 may choose to modify the redemption if desired. For example, user 102 may choose to only use $10 of a $25 gift card. User 102 may choose to split the payment between a plurality of funding sources, such as, but not limited to, the gift card, a credit card, a checking account, a savings account, etc. User 102 may have the option of paying the full amount now, with one or more funding sources, paying a partial amount now, with one or more funding sources, and/or splitting the payment over multiple funding sources. In another embodiment, user 102 has the option to choose a deferred payment option or “pay now” either at the time of the payment request or at a later date.

The next steps involve communication with the merchant device 120 to obtain merchant authorization to withdraw funds on the gift card. These steps occur independently of step 208. They may occur either concurrently with step 208 or after step 208. In another embodiment, obtaining merchant authorization occurs immediately after linking the gift card to the user account and before the purchase is made. Thus, the service provider sweeps the gift card funds into the user account ahead of time (and likely offers a premium/incentive, e.g., “get an extra $5 added to your $100 gift card by loading into wallet”).

At step 210, service provider server 180 receives a transaction identifier from merchant device 120. A transaction identifier is a unique number that is assigned by the merchant to the specific transaction and that is used to identify a single transaction. The transaction identifier is associated with information regarding the transaction, e.g., time, place, amount of purchase, item purchased, etc.

At step 212, the service provider determines the identity of the merchant associated with the request. For example, the service provider makes this determination based on info nation associated with payee device 132, such as the payee device identifier 134. Generally, a specific POS terminal or workstation is assigned a terminal identification number (TID) that can be used to identify the merchant operating the terminal during sales transaction processing and the location of the merchant. The number not only identifies what company is using what specific terminal, but also tracks each POS transaction made at a specific location. In one embodiment, the service provider server 180 takes the number and scans through database 192 to determine which merchant the number is associated with.

Once the merchant is identified, at step 214, the service provider determines if user 102's financial account is linked to a gift card issued by the merchant. For example, the service provider checks database 192 and compares the merchant with the merchants linked to user 102's financial account. If the identified merchant matches a merchant who issued a gift card to user 102, the method continues.

At step 216, the service provider retrieves the value of the gift card by contacting the merchant device 120. Merchant device 120 responds to service provider server 180 and reports the balance, if any, remaining on user 102's gift card. If there is still money in the gift card, the financial transaction proceeds. If there is no money in the gift card for payment, user 102 may be notified and asked to pay using an alternative method.

At step 218, service provider server 180 sends the transaction identifier with a request to redeem the gift card to the merchant. In one embodiment, service provider server 180 contacts merchant device 120 to authorize a withdrawal of funds corresponding to the payment transaction. Merchant device 120 checks the transaction identifier and the amount of the purchase against the available credit. Merchant device 120 can also verify that user 102 is an identified recipient of a gift card and authorize the withdrawal in an amount not exceeding the remaining balance on the gift card. Merchant device 120 then sends an authorization response to the service provider. Merchant device 120 transfers funds associated with the gift card redemption in a full or partial amount to the service provider.

At step 220, service provider server 180 receives the funds from the merchant and deposits them into user 102's financial account. Thus, user 102's account is credited with the gift card redemption.

After the transfer, the service provider may transmit a notification to user 102 and/or the merchant. A confirmation may be sent to merchant device 120 and/or user 102, such as via text, email, voice, or other means. The service provider may generate a receipt showing details of the transaction, including an indication that payment was made and a gift card was used.

As an example, imagine user 102 obtains a $100 gift card from the GAP® store and loads the gift card into his PayPal® wallet. User 102 then walks into a GAP® store, but forgets to bring his gift card. He finds a pair of jeans for $120 and pays for it using his PayPal® card. PayPal® pays for the jeans using funds from user 102's PayPal® account. After the purchase is paid for, PayPal® contacts the GAP® to inform them that user 102 has a GAP® gift card that he wants to redeem. The GAP® transfers money from their account to PayPal®, which then deposits it into user 102's PayPal® account. Thus, only $20 is actually deducted from user 102's PayPal® account.

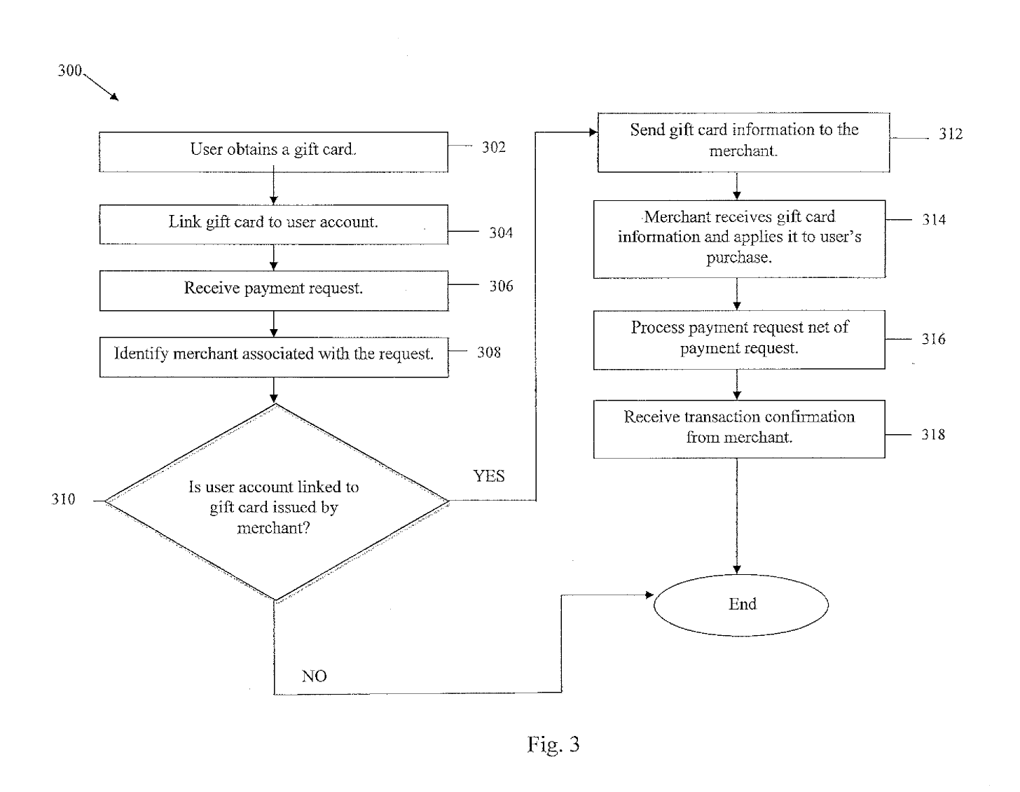

FIG. 3 is a flow chart 300 showing a synchronous method of redeeming a gift card, according to an embodiment. Steps 302-306 are similar to steps 202-206 of FIG. 2, and thus, the descriptions of these steps are omitted for brevity.

In step 308, the service provider determines the identity of the merchant associated with the request, such as in the way described with respect to step 212 of FIG. 2. In step 310, the service provider server 180 determines if user 102's financial account is linked to a gift card issued by the merchant, such as in the way described with respect to step 214 of FIG. 2.

In step 312, service provider server 180 sends information representative of the payment transaction, e.g., gift card number, expiration date of gift card, purchase price, name of user 102, etc., to the merchant. In step 314, merchant device 120 receives the gift card information and applies the information to the purchase. Merchant device 120 validates the gift card number and expiration and checks the amount of the purchase against the available credit. Merchant device 120 can also verify that user 102 is an identified recipient of a gift card and authorize the withdrawal in an amount not exceeding the remaining balance on the gift card. The purchase amount is then applied to the gift card.

In step 316, service provider server 180 processes the payment request. Because the purchase amount was applied to the gift card, the service provider only needs to deduct any remaining amount not covered by the gift card from user 102's financial account.

In step 318, service provider server 180 receives transaction confirmation from the merchant that the gift card was redeemed.

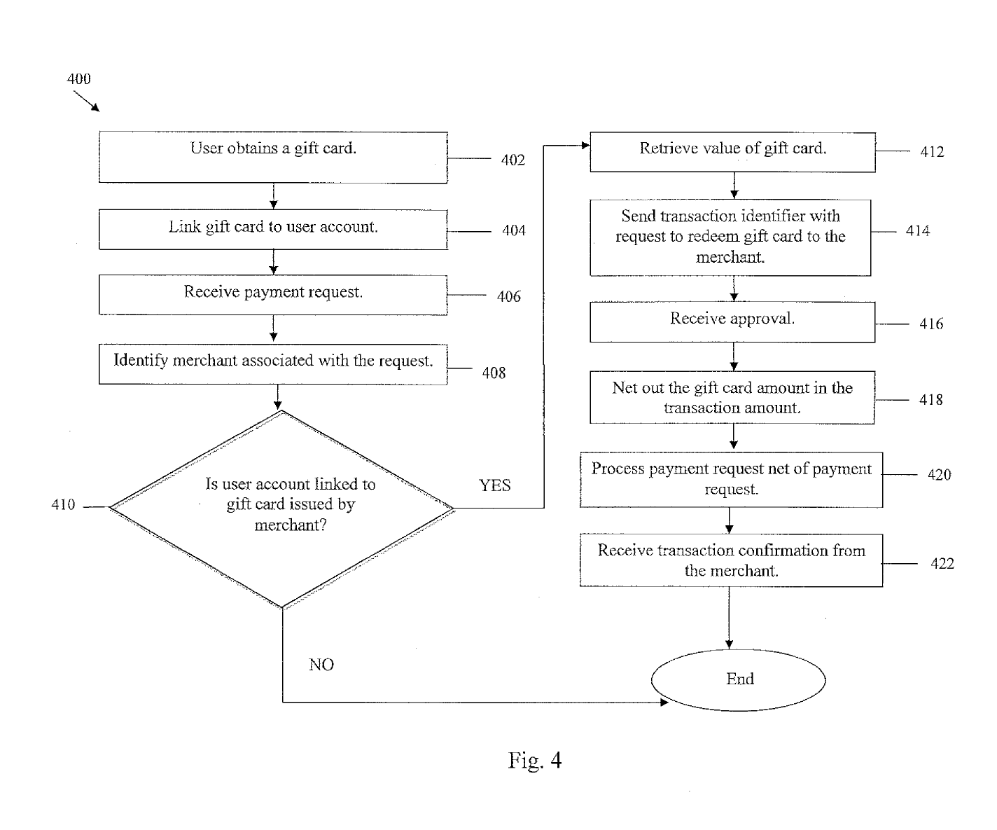

Now moving on to FIG. 4, flow chart 400 illustrates another synchronous method of redeeming a gift card, according to an embodiment. Steps 402-410 are similar to steps 302-310 of FIG. 3, and thus, the descriptions of these steps are omitted for brevity.

In step 412, service provider server 180 retrieves the value of the gift card from the merchant, such as in the way described with respect to step 216 of FIG. 2. In step 414, the service provider sends the merchant transaction identifier with a request to redeem the gift card to the merchant, such as in the way described with respect to step 218 of FIG. 2. In step 416, the service provider receives approval for the transaction from the merchant.

In step 418, the service provider deducts the amount of the gift card from the transaction amount. In step 420, the service provider processes the payment request, deducting any amount not covered by the gift card from user 102's financial account. Finally, at step 422, the service provider receives confirmation from the merchant that the gift card was redeemed. In any of the flow charts 200, 300, 400 a third party gift card provider, such as Blackhawk Network or InComm, may be involved. The third party acts as a middle man between the service provider and the merchant. In those cases, the service provider communicates with the third party, and the third party communicates with the merchant. For example, the service provider server 180 can send payment request details to the third party and receive funds from the third party.

In one embodiment, the service provider sets up a user flag for any user with a valid gift card. The service provider may also set a flag for a payee device identifier 134 so that the service provider knows that the identifier is related to a gift card. For example, Store 689 of the GAP® may be identified as “XYZ” when processed and the service provider knows that it is related to a GAP® gift card. As transactions get authorized and settled, the service provider can check to see if user 102 has a flag that has been set up for a gift card and if that gift card matches a payee device identifier 134 that was used before.

Several advantages are obtained with the use of the methods described herein. One advantage is that any gift card can be redeemed, regardless of who the issuer or merchant is. In addition, user 102 is not required to have the gift card in his possession to conduct a purchase transaction with the merchant. User 102 only needs to carry one card instead of multiple cards to make purchases at various merchant stores. Moreover, user 102 does not need to keep track of the remaining balance on the gift card because the service provider performs that function. An advantage to merchants is the service provider provides a forum for them to send messages to their gift card holders and generate demand by sending the card holder offers. The service provider can provide the merchant with usage metrics to understand how gift cards drive repeat usage and other data points that are of interest to the merchant.

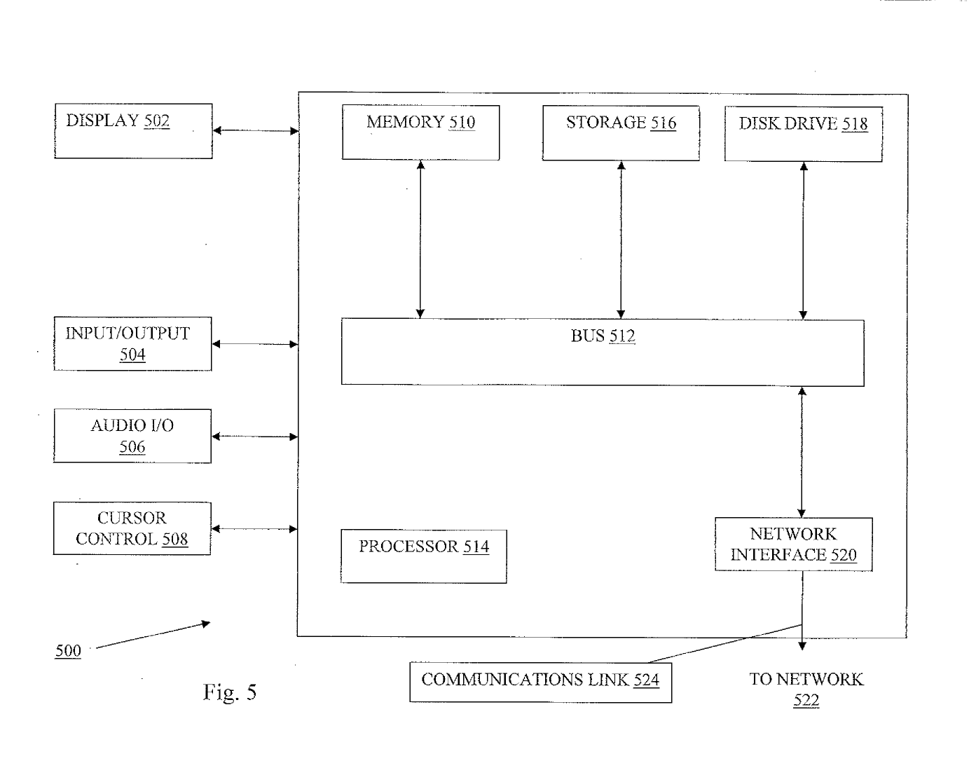

FIG. 5 is a block diagram of a computer system 500 suitable for implementing one or more embodiments of the present disclosure. In various implementations, the merchant device 120, payee device 132, and service provider server 180 may utilize a network computing device (e.g., a network server) capable of communicating with the network. It should be appreciated that each of the devices utilized by senders, receivers, third parties, and service providers may be implemented as computer system 500 in a manner as follows.

Computer system 500 includes a bus 512 or other communication mechanism for communicating information data, signals, and information between various components of computer system 500. Components include an input/output (I/O) component 504 that processes a user (i.e., sender, recipient, chat administrator and/or payment provider) action, such as selecting keys from a keypad/keyboard, selecting one or more buttons or links, etc., and sends a corresponding signal to bus 512. I/O component 504 may also include an output component, such as a display 502 and a cursor control 508 (such as a keyboard, keypad, mouse, etc.). An optional audio input/output component 506 may also be included to allow a user to use voice for inputting information by converting audio signals. Audio I/O component 506 may allow the user to hear audio. A transceiver or network interface 520 transmits and receives signals between computer system 500 and other devices, such as another user device, a chat server, or a payment provider server via network 160. In one embodiment, the transmission is wireless, although other transmission mediums and methods may also be suitable. A processor 514, which can be a micro-controller, digital signal processor (DSP), or other processing component, processes these various signals, such as for display on computer system 500 or transmission to other devices via a communication link 524. Processor 514 may also control transmission of information, such as cookies or IP addresses, to other devices.

Components of computer system 500 also include a system memory component 510 (e.g., RAM), a static storage component 516 (e.g., ROM), and/or a disk drive 518. Computer system 500 performs specific operations by processor 514 and other components by executing one or more sequences of instructions contained in system memory component 510. Logic may be encoded in a computer readable medium, which may refer to any medium that participates in providing instructions to processor 514 for execution. Such a medium may take many forms, including but not limited to, non-volatile media, volatile media, and transmission media. In various implementations, non-volatile media includes optical or magnetic disks, volatile media includes dynamic memory, such as system memory component 510, and transmission media includes coaxial cables, copper wire, and fiber optics, including wires that comprise bus 512. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 524 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a memory device storing user account information, wherein the user account information comprises the user's gift card information; and
one or more processors operable to:
link a gift card issued by a merchant to a financial account of the user;
receive a payment request from the user at a merchant payee device;
process the payment request so that the merchant is paid with funds in the financial account;
receive a transaction identifier from the merchant;
identify the merchant;
verify that the financial account is linked to a gift card issued by the merchant;
retrieve a value of the gift card;
transmit the transaction identifier and a request to redeem the gift card;
receive funds corresponding to a full or partial value of the gift card; and
deposit the received funds into the financial account.

2. The system of claim 1, wherein the one or more processors is further operable to transmit a notification to the user regarding the payment request.

3. The system of claim 2, wherein the one or more processors is further operable to receive a message from the user accepting or declining use of the gift card.

4. The system of claim 2, wherein the one or more processors is further operable to receive a message from the user that a full or partial value of the gift card be redeemed.

5. The system of claim 4, wherein the one or more processors is further operable to request that the full or partial value of the gift card be redeemed.

6. The system of claim 1, wherein the transaction identifier and the request to redeem the gift card are transmitted to a third party.

7. The system of claim 6, wherein the funds corresponding to a full or partial value of the gift card are received from the third party.

8. A method for redeeming a gift card, comprising:
linking a gift card issued by a merchant to a financial account of a user;
receiving a payment request from the user at a merchant payee device;
processing the payment request so that the merchant is paid with funds in the financial account;
receiving a transaction identifier from the merchant;
identifying the merchant;
verifying that the financial account is linked to a gift card issued by the merchant;
retrieving a value of the gift card;
transmitting the transaction identifier and a request to redeem the gift card;
receiving funds corresponding to a full or partial value of the gift card; and
depositing the received funds into the financial account.

9. The method of claim 8, further comprising transmitting a notification to the user regarding the payment request.

10. The method of claim 9, further comprising receiving a message from the user accepting or declining use of the gift card.

11. The method of claim 9, further comprising receiving a message from the user that a full or partial value of the gift card be redeemed.

12. The method of claim 11, further comprising requesting that the full or partial value of the gift card be redeemed.

13. The method of claim 8, wherein the transaction identifier and the request to redeem the gift card are transmitted to a third party.

14. The method of claim 13, wherein the funds corresponding to a full or partial value of the gift card are received from the third party.

15. A non-transitory machine-readable medium comprising a plurality of machine-readable instructions which when executed by one or more processors of a server are adapted to cause the server to perform a method comprising:
linking a gift card issued by a merchant to a financial account of a user;
receiving a payment request from the user at a merchant payee device;
processing the payment request so that the merchant is paid with funds in the financial account;
receiving a transaction identifier from the merchant;
identifying the merchant;
verifying that the financial account is linked to a gift card issued by the merchant;
retrieving a value of the gift card;
transmitting the transaction identifier and a request to redeem the gift card;
receiving funds corresponding to a full or partial value of the gift card; and
depositing the received funds into the financial account.

16. The non-transitory machine-readable medium of claim 15, wherein the method further comprises transmitting a notification to the user regarding the payment request.

17. The non-transitory machine-readable medium of claim 16, wherein the method further comprises receiving a message from the user accepting or declining use of the gift card.

18. The non-transitory machine-readable medium of claim 16, wherein the method further comprises receiving a message from the user that a full or partial value of the gift card be redeemed.

19. The non-transitory machine-readable medium of claim 18, wherein the method further comprises requesting that the full or partial value of the gift card be redeemed.

20. The non-transitory machine-readable medium of claim 15, wherein the transaction identifier and a request to redeem the gift card are transmitted to a third party, and the funds corresponding to a full or partial value of the gift card are received from the third party.
